(19) United States
(12) Patent Application Publication
(10) Pub. No.: US 2021/0221455 A1
(43) Pub. Date: Jul. 22, 2021

(54) LEGGED ROBOT CONTINUOUS HOPPING CONTROL METHOD AND LEGGED ROBOT AND COMPUTER READABLE STORAGE MEDIUM USING THE SAME

(71) Applicant: UBTECH ROBOTICS CORP LTD, Shenzhen (CN)

(72) Inventors: Yuesong Wang, Shenzhen (CN); Hao Dong, Shenzhen (CN); Guoping Yang, Shenzhen (CN); Mingguo Zhao, Shenzhen (CN); Youjun Xiong, Shenzhen (CN)

(21) Appl. No.: 17/092,347

(22) Filed: Nov. 9, 2020

(30) Foreign Application Priority Data
Jan. 22, 2020 (CN) 202010073668.4

(51) Int. Cl. B62D 57/032

(52) U.S. Cl. CPC B62D 57/032

(57) ABSTRACT

The present disclosure provides a legged robot continuous hopping control method as well as a legged robot and a computer readable storage medium using the same. The method includes: dividing each of the phases into a desired entry stage, an actual entry stage, a during stage, and an exit and state transiting stage; detecting a transiting between the stages of the acceleration phase, the flight phase, and the deceleration phase to obtain a corresponding state detecting result; updating state information of the robot based on the state detecting result; and controlling the robot to continuously hop by transiting between the stages of the acceleration phase, the flight phase, and the deceleration phase according to the updated state information. In this manner, the stability of the continuous hopping of the legged robot can be greatly improved.

### CROSS REFERENCE TO RELATED APPLICATIONS

The present disclosure claims priority to Chinese Patent Application No. 202010073668.4, filed Jan. 22, 2020, which is hereby incorporated by reference herein as if set forth in its entirety.

### BACKGROUND

### 1. Technical Field

The present disclosure relates to robot control technology, and particularly to a legged robot continuous hopping control method as well as a legged robot and a computer readable storage medium using the same.

### 2. Description of Related Art

During the walking of a legged robot, the program (of the control system) of the robot will determine whether the robot is the states of supported by one leg or two legs based on sensor information of the robot, and output a status determination result to a control planning algorithm to perform the corresponding operation, that is, to use a finite state machine suitable for walking. However, the finite state machine is no longer applicable during the hopping and running of the legged robot, because the robot has no contact with the ground and the center of mass follows a ballistic trajectory during flight, which is completely different from the state when the robot is on the ground. Therefore, for the motion controlling of the robot in its hopping and running, it is necessary to provide a method or model for determining the state of the robot, thereby determining the action for the robot to take timely according to the state of the robot.

### BRIEF DESCRIPTION OF THE DRAWINGS

To describe the technical schemes in the embodiments of the present disclosure more clearly, the following briefly introduces the drawings required for describing the embodiments. It should be understood that, the drawings in the following description merely show some embodiments of the present disclosure, hence should not be regarded as limitations to the scope of the present disclosure. In the figures, similar elements are numbered similarly.

FIG. 1A is a flow chart of an embodiment of a legged robot continuous hopping control method according to the present disclosure.

FIG. 1B is a schematic diagram of a finite state machine in the embodiment of FIG. 1A.

FIG. 1C is a schematic diagram of the hopping of a robot in the embodiment of FIG. 1A.

FIG. 2 is a schematic diagram of a single-legged robot in the embodiment of FIG. 1A.

FIG. 3 is a schematic diagram of the processes of the continuous hops of different heights performed by the single-legged robot in the embodiment of FIG. 2.

FIG. 4 is a schematic diagram of the processes of the continuous hops of different heights performed by the single-legged robot in the embodiment of FIG. 2 in the case that a wooden block of unknown height is suddenly inserted into the below of the sole of the robot.

FIG. 5 is a schematic diagram of the processes of the continuous hops of different heights performed by the single-legged robot in the embodiment of FIG. 2 in the case that a wooden block of unknown height is suddenly removed from the below of the sole of the robot.

FIG. 6 is a schematic block diagram of an embodiment of a finite state machine according to the present disclosure.

### DETAILED DESCRIPTION

The technical solutions in the embodiments of the present disclosure will be clearly and completely described below with reference to the drawings. Apparently, the described embodiments are part of the embodiments of the present disclosure, not all of the embodiments.

The components in the embodiments of the present disclosure that are illustrated in the drawings can generally be arranged and designed in various manners. Therefore, the following detailed description of the embodiments of the present disclosure provided in the drawings is not intended to limit the scope of the present disclosure to be protected, but merely fore representing the embodiments of the present disclosure. Based on the embodiments, all other embodiments obtained by those skilled in the art without creative efforts shall be within the scope of the present disclosure.

Hereinafter, various embodiments of the present disclosure will be described with more details. The present disclosure may have various embodiments, and adjustments and changes may be made therein. However, it should be understood that, there is no intention to limit the various embodiments of the present disclosure to the specific embodiments disclosed herein, but the present disclosure should be understood to cover all the adjustments, equivalents and/or alternatives those falling within the spirit and scope of the various embodiments of the present disclosure.

In the following descriptions, the terms “including”, “comprising”, “having” and their cognates that are used in the embodiments of the present disclosure are only intended to represent specific features, numbers, steps, operations, elements, components, or combinations of the foregoing items, and should not be understood as excluding the possibilities of the existence of one or more other features, numbers, steps, operations, elements, components or combinations of the foregoing items or adding one or more features, numbers, steps, operations, elements, components or combinations of the foregoing items.

In addition, in the present disclosure, the terms “first”, “second”, “third”, and the like are only used for distinguishing, and cannot be understood as indicating or implying relative importance.

Unless otherwise defined, all terms (including technical and scientific terms) used herein have the same meanings as commonly understood by those skilled in the art to which the embodiments of the present disclosure belong. The terms (e.g., the terms those defined in commonly used dictionaries) will be interpreted as having the same meaning as the contextual meaning in the relevant technology and will not be interpreted as having idealized or overly formal meanings, unless clearly defined in the embodiments of the present disclosure.

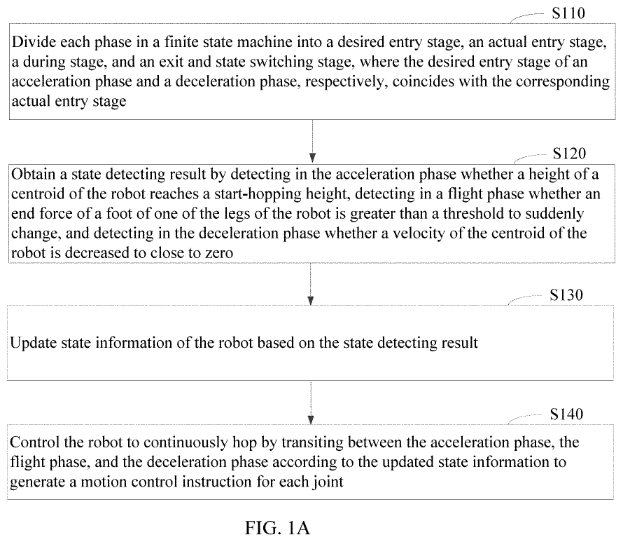

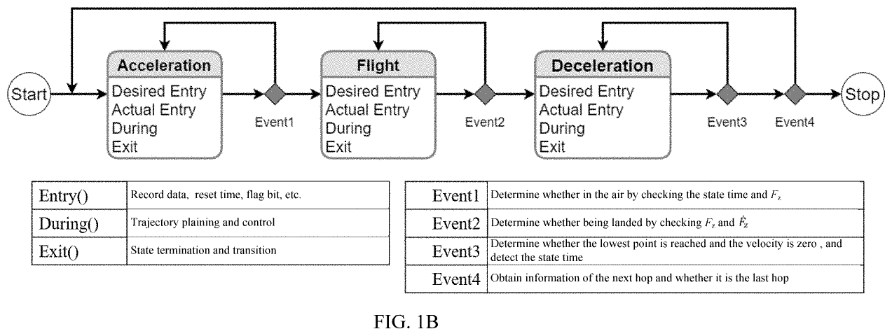

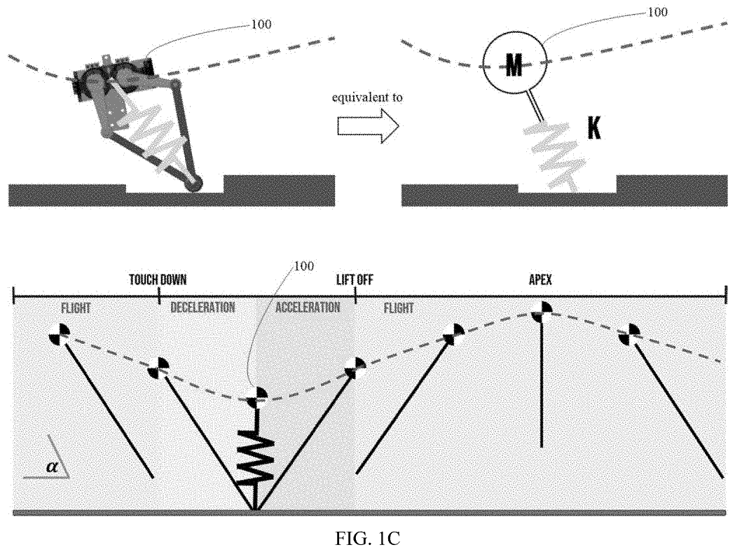

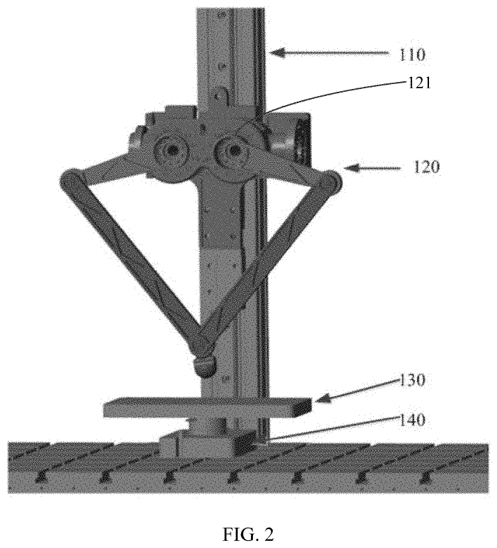

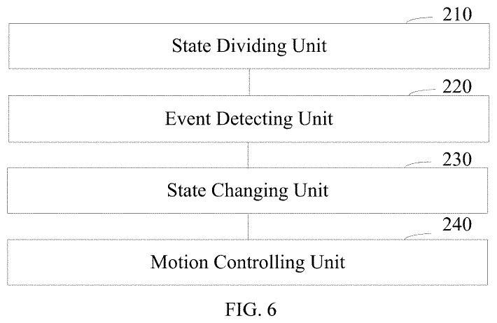

FIG. 1A is a flow chart of an embodiment of a legged robot continuous hopping control method according to the present disclosure. In this embodiment, a legged robot continuous hopping control method for a legged robot is provided, which controls the robot to perform continuous hopping movements. The method is based on a finite state machine for the robot to perform continuous hopping movements. The finite state machine includes a plurality of states, where the states include an acceleration phase, a flight phase, and a deceleration phase (i.e., each state in the finite state machine respectively corresponds to each phase). The input of the finite state machine are sensor data of the robot and the system time, and the output of the finite state machine is the state at which of the robot is in, the time of being in the state, and records of other state information of the robot (e.g., the height and the velocity of the centroid of the robot when entering the state). By implementing the finite state machine at the algorithm level, the robot can better achieve continuous and stable hopping movements. The method is a computer-implemented method executable for a processor, which may be implemented through and applied to a legged robot as shown in FIG. 2 or a finite state machine as shown in FIG. 6. As shown in FIG. 1A, the method mainly includes the following steps.

S110: dividing each of the phases into a desired entry stage, an actual entry stage, a during stage, and an exit and state transiting stage, where the desired entry stage of the acceleration phase and the deceleration phase, respectively, coincides with the corresponding actual entry stage.

In which, when the robot is continuously hopping and running, the states of the robot usually includes the acceleration phase, the flight phase, and the deceleration phase. In order to better control the continuous hopping of the robot, each phase is divided into the desired entry stage, the actual entry stage, the during stage, and the exit and state transiting stage, where the phases are determined based on the motion characteristics and control needs of the robot. Except for the during stage, each of the other stages is a stage of single control cycle for recording key data of the robot such as reset flag bit and reset timer.

The planned take-off time of robot is likely to differ from the actual take-off moment due to the presence of the error and delay of the actuator of the robot. Hence, during the transition of the robot's hopping state, it is necessary to record key data of the robot such as the position and velocity of the centroid for analysis purposes upon each state entering and exiting moment. In the flight phase, the desired entry moment differs from the actual entry moment due to the error and delay. However, in the acceleration phase and the deceleration phase, the desired entry moment coincides with actual entry moment because these two states are driven by events. The deceleration phase begins when robot detects its landing, and it switches into the acceleration phase when the sign of vertical center of mass robot velocity diverts.

S120: obtaining a state detecting result by detecting in the acceleration phase whether a height of a centroid of the robot reaches a start-hopping height, detecting in the flight phase whether an end force of a foot of one of the legs of the robot is greater than a threshold to suddenly change, and detecting in the deceleration phase whether a velocity of the centroid of the robot is decreased to close to zero.

When it transits between the four stages of each phase and between the adjacent phases, the corresponding states of the robot are different. In which, the transition is driven by the trigger of an event such as the force upon a sole of the robot being greater than a threshold in the flight phase. If the force is greater than the threshold, it means that the robot is landed, and it enters the exit and state transiting stage of the flight phase in the current control cycle and enters the deceleration phase in the next cycle.

S130: updating state information of the robot based on the state detecting result.

In which, when the above-mentioned state detecting result is obtained, the control system of the robot needs to update the corresponding state information of the robot in time so to control the hopping process of the robot in time.

In this embodiment, the above-mentioned state information includes state flag information, state timing information, and a state name that correspond to each stage. In which, the state flag information indicates the state of the robot, for example, state=1 indicates the acceleration phase, state=2 indicates the flight phase, and state=3 indicates the deceleration phase. The state name is, for example, the acceleration phase, the flight phase, or the deceleration phase.

S140: controlling the robot to continuously hop by transiting between the stages of the acceleration phase, the flight phase, and the deceleration phase according to the updated state information.

In which, the output of the finite state machine, that is, the updated state information, state timing information, and other state information (e.g., the position and the velocity of the centroid) are calculated through a control algorithm so as to generate motion control instructions for each joint of the robot, thereby controlling the robot to hop continuously. FIG. 1B is a schematic diagram of a finite state machine in the embodiment of FIG. 1A, and FIG. 1C is a schematic diagram of the hopping of a robot in the embodiment of FIG. 1A. Referring to FIG. 1B and FIG. 1C, in this embodiment, the phase and stage in the current control cycle is determined based on the phase and stage in the previous control cycle and sensor data of the robot in the current control cycle, so as to execute corresponding operations of the finite state machine and output an operation result to a planning and control unit (e.g., the control system) of the robot. As an example, the robot at the lowest point is taken as an initial state first, that is, the start time of the acceleration phase, and it enters the finite state machine. In the first control cycle, the desired entry stage and the actual entry stage in the acceleration phase coincide with each other, and a timer starts timing. After the second control cycle, it enters the during phase in the acceleration phase, and detects an event triggered in the acceleration phase. In which, the event in the acceleration phase is defined as that the robot has reached a start-hopping height. If the event is triggered (i.e., the robot is determined to have reached the start-hopping height), it enters the exit and state transiting stage in the current control cycle and enters the desired entry stage of the flight phase in the next control cycle; otherwise, it retains in the during stage of the acceleration phase and the timer is increased by 1 time unit of the control cycle. After it enters the flight phase, the first control cycle is in the desired entry stage, and it enters the during stage after the second control cycle. At the same time, it will also calculate the force upon a sole of a foot of a leg of the robot based on the force upon an output shaft of a servo of a joint connect to the leg. In the time that the force upon the sole is smaller than a certain threshold, which is taken as the time actually entering the flight phase. The event in the flight phase is defined as that the force upon the sole has increased suddenly (for example, when the robot is landed). If the event is triggered, it enters the exit and state switching stage in this control cycle and enters the deceleration phase in the next control cycle; otherwise, it is still in the during stage of the flight phase, and the timer is increased by 1 time unit of the control cycle. The desired entry stage and the actual entry stage of the deceleration phase coincide with the each other, and it enters the during after the second control cycle. The event in the deceleration phase is defined as that the velocity of the centroid is smaller than a certain threshold very close to zero. If the event is triggered, it indicates that the deceleration phase has been completed, and it enters the exit and state switching stage and checks whether this hopping is the last hopping of the robot, and if yes, it stops; otherwise, it enters the acceleration phase in the next control cycle. If the event is not triggered, the robot is still in the during stage of the deceleration phase, and the timer is increased by 1 time unit of the control cycle. When entering the acceleration phase, a hopping counter is incremented by 1.

FIG. 2 is a schematic diagram of a single-legged robot in the embodiment of FIG. 1A. In this embodiment, a single-legged robot 100 including a storage and a processor is provided. The storage is configured to store a computer program including instructions for implementing the steps in the above-mentioned method as shown in FIG. 1A, and the processor is coupled to the storage so as to retrieve the computer program to execute the instructions so that the above-mentioned method as shown in FIG. 1A is implemented. As shown in FIG. 2, the single-legged robot 100 has two series elastic actuators 120 disposed in parallel, where the two series elastic actuators 120 jointly compose a leg, and each series elastic actuators 120 has a joint 121. The joint 121 has a servo driven by a motor. The movement of the series elastic actuator 120 is realized by the motor to rotate an output shaft of the servo which is connected to the series elastic actuator 120. The joint position, the joint velocity and the joint end torque of each series elastic actuator can be directly measured. In which, there are a vertical guide rail 110, two series elastic actuators 120, an experimental ground 130, and a pressure sensor 140. In other embodiments, other legged robot with a plurality of legs can be provided.

In which, the pressure sensor 140 under the experimental ground 130 is mainly used to measure the action force between the single-legged robot 100 and the experimental ground 130 in an objective manner, so as to calculate the time of the single-legged robot 100 to hop and to be in the air in the flight phase.

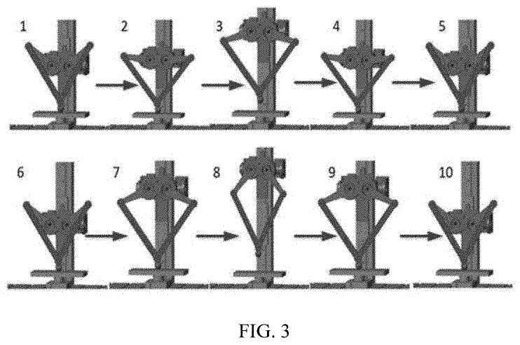

The single-legged robot 100 adopts the finite state machine in the above-mentioned legged robot continuous hopping control method. Each state (i.e., the phase) of the single-legged robot 100 is divided into the desired entry stage, the actual entry stage, the during stage, and the exit and state transiting stage. During the hop of the single-legged robot 100, the state information of the single-legged robot 100 can be updated in real time. The required state information is output to the planning and control unit so as to generate motion control instructions for the actuators. Consequently, the robot is able to hop in different patterns (e.g., height and trajectory) upon given the required state information. FIG. 3 is a schematic diagram of the processes of the continuous hops of different heights performed by the single-legged robot in the embodiment of FIG. 2. As shown in FIG. 3, at the hopping process of sub-diagrams 6-10, the robot realizes the continuous hop of different height from the hopping process of sub-diagrams 1-5.

In which, since each state of the robot is divided into a plurality of stages, the single-legged robot 100 can transit its state between the stages of the acceleration phase, the flight phase, and the deceleration phase to generate the above-mentioned motion control instructions, thereby being able to control the hopping height, the flight time, and the hopping trajectory of the robot separately, hence the anti-interference capability during continuous hopping can be greatly enhanced.

As an example, in the case that the above-mentioned finite state machine is not applied, a wooden block of unknown height is suddenly inserted into the below of a sole (of the leg of) of the robot when the single-legged robot 100 is in the air to cause the single-legged robot 100 to land earlier, and then the wooden block is suddenly removed from the below of the sole of the robot to cause the single-legged robot 100 to land latter. As a result, the continuous hopping movement of the single-legged robot 100 will out of control.

After the above-mentioned finite state machine is applied, the single-legged robot 100 will keep detecting the transiting between the during stage of the flight phase and the exit and state transiting stage of the flight phase. When the sole of the robot 100 is in contact with the experimental ground 130, it will first enter the exit and state transiting stage of the flight phase, and enter the desired entry stage and the actual entry stage of the deceleration phase in the next control cycle, and then execute the subsequent control process, hence the overall hopping stability of the hopping process of the robot can be greatly enhanced.

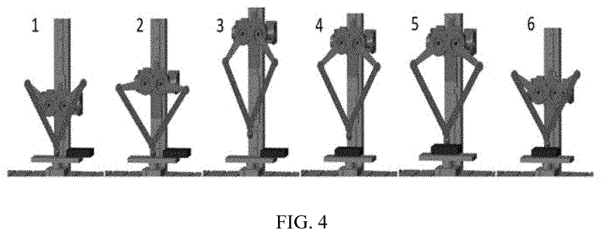

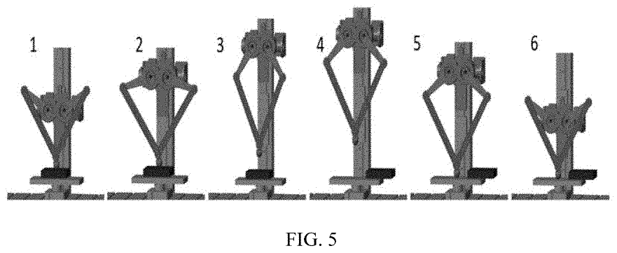

FIG. 4 is a schematic diagram of the processes of the continuous hops of different heights performed by the single-legged robot in the embodiment of FIG. 2 in the case that a wooden block of unknown height is suddenly inserted into the below of the sole of the robot. As shown in FIG. 4, in which, sub-diagrams 1-6 show the process of suddenly inserting the wooden block of unknown height into the below of the sole of the robot. FIG. 5 is a schematic diagram of the processes of the continuous hops of different heights performed by the single-legged robot in the embodiment of FIG. 2 in the case that a wooden block of unknown height is suddenly removed from the below of the sole of the robot. As shown in FIG. 5, in which, sub-diagrams 1-6 show the process of suddenly removing the wooden block from the below of the sole of the robot.

In the above-mentioned legged robot continuous hopping control method, each state (i.e., each of the phases) of the robot is divided into the desired entry stage, the actual entry stage, the during stage, and the exit and state transiting stage, thereby composing the finite state machine. In the hopping process of the robot, it is capable of obtaining the updated state information of the robot of the next time in real time, so as to output the motion control instructions for each joint of the robot, so that the robot can transit of the state between the different stages of the acceleration phase, the flight phase, and the deceleration phase according to the above-mentioned motion control instructions, thereby being able to control the hopping height, the flight time, and the hopping trajectory of the robot separately. The functions of detecting and determining the state of the robot as well as transiting the state is extracted from the control process of the robot to form a separate module and decouple from other parts, which makes the overall cost of the maintenance of the codes of the robot greatly reduced, and the corresponding control process is more precise and concise. With the processing of the above-mentioned method, the variable height hops, the variable in-air time hops, the variable hop trajectory hops, and the continuous hops of the robot eventually can be realized, which greatly improves the stability of the continuous hops of the robot, and provides a reliable state machine module framework for more number and more complicated hopping and running experiments of biped and quadruped robots.

In one embodiment, step S120 includes the following steps.

1) calculating a vertical velocity of the centroid of the robot, obtaining a corresponding velocity direction and velocity changing direction of the velocity, and determining whether the vertical velocity of the centroid is greater than a preset velocity threshold close to zero.

When determining whether the robot is in the during stage of the acceleration phase, the vertical velocity of the centroid of the robot needs to be obtained and determined.

In one embodiment, the preset velocity threshold is zero, thereby determining whether the vertical velocity of the centroid of the robot is greater than zero.

2) determining the robot as being in the during stage of the acceleration phase, if the vertical velocity of the centroid is greater than the preset velocity threshold and the corresponding velocity direction and velocity changing direction of the velocity are upward.

In which, the above-mentioned preset velocity threshold is theoretically zero, but in actual applications, the value of the preset velocity threshold can be a value close to zero. In other words, when the vertical velocity of the centroid is greater than the above-mentioned preset velocity threshold while the velocity direction and the velocity changing direction are upward, the robot can be considered to be in the during stage of the acceleration phase.

In one embodiment, the preset velocity threshold is zero, and when the vertical velocity of the centroid is greater than zero and the velocity direction and the velocity changing direction are upward, it is determined that the robot is in the during stage of the acceleration phase.

In which, in the acceleration phase, the robot starts to accelerate upwards. At each moment, the control instructions for the servo of each joint is calculated through inverse dynamics and inverse kinematics based on the planned position (comp), velocity (comv), and acceleration (coma) of the centroid. If the servo is a positional servo, its corresponding joint angle and angular velocity are calculated; if the servo is a force control servo, a joint torque is calculated and transmitted to the servo.

3) obtaining a planned transiting time of the robot to transit from the acceleration phase to the flight phase according to a centroid acceleration planning trajectory, determining whether the planned transiting time is up, and determining the robot as having entered the exit and state transiting stage of the acceleration phase if the planned transiting time is up and going to enter the desired entry stage of the flight phase in a next control cycle of the robot.

In which, in the during stage of the acceleration phase, the robot will keep performing ground-leaving detections. When changing from the acceleration phase to the flight phase, due to the tracking error of the motion of the robot, the robot has a planned ground-leaving time and an actual ground-leaving time, and the two times are often different, where the actual ground-leaving time of the robot is usually the later. The robot first enters from the acceleration phase to the flight phase according to the centroid acceleration planning trajectory. According to the centroid acceleration planning trajectory, the planned transiting time of the robot to change from the acceleration phase to the flight phase can be obtained, so as to determine whether the planned transiting time has come. When the planned transiting time comes, it determines that the robot has entered the exit and state transiting stage of the acceleration phase, and enters the desired entry phase of the flight phase in the next control cycle after the exit and state transiting stage of the acceleration phase ends.

4) calculating a vertical force between the foot of the robot and ground F_{z}, obtaining a corresponding differentiation of the vertical force based on the current and the last control cycle \dot{F}_{z}. The state transitions are primarily took place by detecting the sudden change of these two variables F_{z} and \dot{F}_{z}.

In which, when the robot has actually entered the flight phase, the theoretical value of the vertical force between the sole of the robot and the ground is zero. In actual applications, the force F_{z} between sole and ground rapidly reduced to around zero, and a threshold can be used for determining whether the robot gets into the flight phase. The differentiation of the force F_{z}, that is, the variable \dot{F}_{z} will gradually become smaller.

Therefore, by calculating the vertical force between the sole of the robot and the ground and obtaining the corresponding force changing direction, it can be determined whether the robot has entered the flight phase.

In this embodiment, the vertical force between the sole of the robot and the ground is measured through the sensor installed on the sole.

5) determining the robot as having entered the actual entry stage of the flight phase, and going to be in the during stage in the flight phase in the next control cycle, if the changing direction of the vertical force is gradually decreasing and the vertical force is smaller than or equal to the first preset action force threshold.

In one embodiment, the first preset action force threshold is zero. When the magnitude of vertical force after differentiation (i.e., the variable \dot{F}z) is gradually decreasing and the vertical action force is zero, it is determined that the robot has entered the actual entry stage of the flight phase.

In one embodiment, the first preset action force threshold is close to zero, for example, 0.0001N (Newton). When the magnitude of vertical force after differentiation (i.e., the variable \dot{F}_{z}) is gradually decreasing and the vertical force is smaller than or equal to 0.0001N, it is determined that the robot has entered the actual entry stage of the flight phase.

6) determining the robot as being in the during stage of the flight phase, if the vertical force is smaller than or equal to the first preset action force threshold and retained unchanged.

7) determining the robot as having entered the exit and state transiting stage of the flight phase and going to enter the desired entry stage and the actual entry stage of the deceleration phase in the next control cycle, if the changing direction of the vertical force is gradually increasing and the vertical force is greater than or equal to a second preset action force threshold.

In which, the theoretical value of the second preset action force threshold is zero, or a value close to zero such as 0.0001N. When the magnitude of vertical force after differentiation is suddenly increasing and the vertical force is greater than or equal to 0.0001N, it is determined that the robot has entered the exit and state transiting stag of the flight phase and will enter the desired entry phase and the actual entry stage of the deceleration phase in the next control cycle.

In which, the magnitudes of the first preset action force threshold and the second preset action force threshold can be the same.

In which, the desired entry stage and the actual entry stage of the deceleration phase can be considered to be basically coincident or the exactly same. After the robot enters the exit and state transiting stage of the flight phase, it will enter the desired entry phase and the actual entry stage of the deceleration phase at the same time in the next control cycle.

8) determining the robot as being in the during stage of the deceleration phase, if the corresponding velocity direction is downward, the corresponding velocity changing direction is upward, and the velocity in the vertical direction of the centroid is greater than the preset velocity threshold.

In which, after the robot enters the deceleration phase from the flight phase, the corresponding vertical velocity of the centroid becomes smaller and smaller, and in this case the corresponding velocity changing direction is upward and the robot is in the deceleration state. In this time, if the vertical velocity of the centroid is greater than the preset velocity threshold, it can be determined that the robot is still in the during stage of the deceleration phase.

In which, the theoretical value of the above-mentioned preset velocity threshold is usually zero, and a value close to zero such as 0.0001 m/s can also be used.

9) determining the robot as having entered the exit and state transiting stage of the deceleration phase and going to enter the desired entry stage and the actual entry stage of the acceleration phase in the next control cycle, if the velocity direction is downward until the velocity in the vertical direction of the centroid is smaller than or equal to the preset velocity threshold.

In which, the desired entry stage and the actual entry stage of the acceleration phase coincide, the robot enters the desired entry phase and the actual entry stage of the acceleration phase at the same time in the next control cycle after entering the exit and state transiting stag of the deceleration phase.

The above-mentioned steps are described from the robot in the during stage of the acceleration phase to obtain the corresponding state detecting result by detecting the transiting between the stages of the acceleration phase, the flight phase, and the deceleration phase. The description in the forgoing order is only to conform to the general logical habit, and in the actual detection process, the detection of the transiting between different stages can also be performed at the same time, which is the not limited to the above-mentioned order.

In one embodiment, a pressure sensor is disposed on the sole of the robot, and the step of calculating the vertical force between the sole of the robot and the ground uses the formula of:

\vec{F}=R_{foot}·\vec{F}ₛₑₙₛₒᵣ;

where, R_{foot} is a posture matrix of the sole of the robot, \vec{F}ₛₑₙₛₒᵣ is a measured value of the pressure sensor, and \vec{F} is the vertical force.

In one embodiment, a torque sensor is disposed on the sole of the robot, and the step of calculating the vertical force between the sole of the robot and the ground uses the formula of:

\vec{F}=(J^{T})⁻¹·\vec{τ};

where, J^{T} is a transposed matrix of a Jacobian matrix of the centroid of the robot with respect to each joint, \vec{τ} is a column vector composed of the torque of each joint of the robot obtained using the torque sensor, and \vec{F} is the vertical force.

In one embodiment, the step of calculating the vertical velocity of the centroid of the robot uses the formula of:

\vec{V}_{com}=J·\dot{Θ̅};

where, \dot{Θ̅} is an angular velocity corresponding to each joint of the robot, J is a Jacobian matrix of the centroid of the robot with respect to each joint, and \vec{V}_{com} i the velocity of the centroid of the robot. In which, the vertical velocity of the centroid is a vertical component of \vec{V}_{com}.

In which, based on the planned position (comp), velocity (corny), acceleration (coma) of the centroid, the control instructions for the servo of each joint is calculated through inverse dynamics and inverse kinematics, thereby further obtaining the angular velocity Θ corresponding to each joint of the robot.

In one embodiment, the state information includes a state name, a desired entry flag, an actual entry flag, a during flag, and an exit and state transiting flag, and step S130 includes the following steps.

A) setting the during flag corresponding to the acceleration phase as valid, if the state detecting result indicates that the robot is in the during stage of the acceleration phase.

In which, if the robot is in the during stage of the acceleration phase, the desired entry flag, the actual entry flag, and the exit and state transiting flag are all set to invalid (i.e., cleared to zero), and the corresponding during flag is set to valid.

B) setting the exit and state transiting flag corresponding to the acceleration phase as valid if the state detecting result indicates that the robot has entered the exit and state transiting stage of the acceleration phase, and setting the exit and state transiting flag corresponding to the flight phase as invalid and setting the desired entry flag corresponding to the flight phase as valid if the robot enters the desired entry stage of the flight phase in the next control cycle.

In which, after the exit and state transiting stage ends, the robot will enter the desired entry phase of the flight phase in the next control cycle. At this time, the corresponding exit and state transiting flag of the flight phase needs to be set to invalid, and the corresponding desired entry flag of the flight phase needs to be set to valid.

C) setting the desired entry flag corresponding to the flight phase as invalid and setting the actual entry flag corresponding to the flight phase as valid if the state detecting result indicates that the robot has entered the actual entry stage of the flight phase, and setting the actual entry flag corresponding to the flight phase as invalid if the robot is in the during stage of the flight phase in the next control cycle.

In which, after the actual entry stage of the flight phase ends, the actual entry flag needs to be set to invalid. Furthermore, if the robot will be in the during stage of the flight phase in the next control cycle, it needs to set the during flag of the flight phase to valid.

D) setting the exit and state transiting flag corresponding to the flight phase as valid if the state detecting result indicates that the robot has entered the exit and state transiting stage of the flight phase, setting the exit and state transiting flag corresponding to the flight phase as invalid and setting the desired entry flag and the actual entry flag corresponding to the deceleration phase as valid if the robot enters the desired entry stage and the actual entry stage of the deceleration phase in the next control cycle, and setting the desired entry flag and the actual entry flag corresponding to the deceleration phase as invalid and setting the during flag corresponding to the deceleration phase as valid if the robot is in the during stage of the deceleration phase.

E) setting the exit and state transiting flag corresponding to deceleration phase as valid if the state detecting result indicates that the robot has entered the exit and state transiting of the deceleration phase, and setting the exit and state transiting flag corresponding to deceleration phase as invalid and setting the desired entry flag and the actual entry flag corresponding to the acceleration phase as valid if the robot enters the desired entry stage and the actual entry stage of the acceleration phase in the next control cycle.

In an embodiment, step S140 includes:

a) controlling the robot to enter the desired entry stage using the updated state name, resetting a timer, and generating an initial centroid planning trajectory, if the updated desired entry flag is valid.

In which, the robot obtains the updated state information in real time. If the obtained updated desired entry flag is valid, it needs to control the robot to enter the corresponding desired entry stage, reset the timer, and generate the initial centroid planning trajectory based on the updated state name (i.e., the acceleration phase, the flight phase, or the deceleration phase).

When the corresponding desired entry phase ends, the corresponding desired entry flag is set to invalid.

b) controlling the robot to enter the actual entry stage using the updated state name and calculating and recording motion parameter information of the robot, if the updated actual entry flag is valid.

In which, when the robot is controlled to enter the corresponding actual entry stage, the corresponding motion parameter information of the robot is calculated and recorded. After the robot has controlled to enter the corresponding actual entry stage, the actual entry flag needs to be further set to invalid (i.e., cleared to zero).

In this embodiment, the above-mentioned motion parameter information includes the corresponding centroid height information and centroid velocity information when the robot enters the corresponding actual entry stage.

c) controlling the robot to enter the during stage using the updated state name and performing a centroid trajectory planning and a centroid velocity control based on the initial centroid planning trajectory and the motion parameter information, if the updated during flag is valid.

In which, if the updated during flag of the flight phase is valid, the robot is controlled to enter the corresponding during stage using the updated state name, and the robot enters the during stage of the flight phase. At this time, the centroid trajectory planning and the centroid velocity control of the flight phase can be performed based on the initial centroid planning trajectory and the motion parameter information.

d) controlling the robot to enter the terminating and transiting stage using the updated state name, if the updated exit and state transiting flag is valid.

FIG. 6 is a schematic block diagram of an embodiment of a finite state machine according to the present disclosure. As shown in FIG. 6, in this embodiment, a finite state machine 200 for a legged robot to perform continuous hopping movements is provided, which controls the legged robot as shown in FIG. 2 to perform continuous hopping movements. The finite state machine 200 includes a plurality of states, where the states include an acceleration phase, a flight phase, and a deceleration phase. The finite state machine 200 includes:

a state dividing unit 210 configured to divide each of the phases into a desired entry stage, an actual entry stage, a during stage, and an exit and state transiting stage, where the desired entry stage of the acceleration phase and the deceleration phase, respectively, coincides with the corresponding actual entry stage;

an event detecting unit 220 configured to detect a transiting of the state of the robot between the stages of the acceleration phase, the flight phase, and the deceleration phase to obtain a corresponding state detecting result;

a state changing unit 230 configured to update state information of the robot based on the state detecting result; and

a motion controlling unit 240 configured to control the robot to transit between the stages of the acceleration phase, the flight phase, and the deceleration phase based on the updated state information to control the robot to continuously hop.

In this embodiment, each of the above-mentioned units is implemented in the form of software, which can be computer program(s) stored in a memory of the legged robot and executable on a processor of the legged robot. In addition, a non-transitory computer readable storage medium storing a computer program including instruction is also provided. The computer program executes the above-mentioned method when being executed by a processor.

In the embodiments provided in the present disclosure, it should be understood that, the disclosed apparatus (device) and method may also be implemented in other manners. The device embodiments described above are only schematic. For example, the flowcharts and schematic diagrams in the drawings show the possible implementation of the system architecture, the functions, and the operations of the apparatus, methods, and computer program products according to the embodiments of the present disclosure. In this regards, each block in the flowchart or block diagram may represent a module, program segment, or part of the code, and the module, program segment, or the part of the code includes one or more executable instructions for realizing the specified logical function. It should also be noted that, in alternative implementations, the functions marked in the blocks may also be executed in a different order from the order marked in the drawings. For example, two consecutive blocks can actually be executed in parallel, or they can be executed in the reverse order, which depend on the functions involved. It should also be noted that, each block in the schematic diagram and/or flowchart, and the combination of the blocks in the schematic diagram and/or flowchart, can be realized using a dedicated hardware-based system that performs specified functions or actions, or can be realized by a combination of dedicated hardware and computer instructions.

In addition, the functional modules or units in each of the embodiments of the present disclosure can be integrated to form an independent part, or each module can exist alone, or two or more modules can be integrated to form an independent part.

If the function is implemented in the form of a software function module and sold or used as an independent product, it can be stored in a non-transitory computer readable storage medium. Based on this understanding, the essence of the technical solution of the present disclosure, its part that contributes to the prior art, or a part of the technical solution can be embodied in the form of a software product, where the computer software product is stored in a storage medium which includes a plurality of instructions for making a computer device (e.g., a smart phone, a personal computer, a server, or a network device) to execute all or part of the steps of the method described in each embodiment of the present disclosure. The above-mentioned storage media include a USB disk, a mobile hard disk, a read-only memory (ROM), a random access memory (RAM), a magnetic disk, or other media storing program codes such as an optical disk.

The forgoing is only the specific embodiment of the present disclosure, while the scope of the present disclosure is not limited thereto. For those skilled in the art, various equivalent modifications or replacements that can be easily conceived within the technical scope of the present disclosure should be included within the scope of the present disclosure.

What is claimed is:

1. A computer-implemented method for controlling a legged robot to continuously hop based on a finite state machine; wherein the robot has one or more legs each having at least a joint; wherein the finite state machine comprises states comprising an acceleration phase, a flight phase, and a deceleration phase; wherein the method comprises steps of:
dividing each of the phases into a desired entry stage, an actual entry stage, a during stage, and an exit and state transiting stage, wherein the desired entry stage of the acceleration phase coincides with the actual entry stage of the acceleration phase, and the desired entry stage of the deceleration phase coincides with the actual entry stage of the deceleration phase;
obtaining a state detecting result by detecting in the acceleration phase whether a height of a centroid of the robot reaches a start-hopping height, detecting in the flight phase whether an end force of a foot of one of the legs of the robot is greater than a threshold to suddenly change, and detecting in the deceleration phase whether a velocity of the centroid of the robot is decreased to close to zero;
updating state information of the robot based on the state detecting result; and
controlling the robot to continuously hop by transiting between the acceleration phase, the flight phase, and the deceleration phase according to the updated state information to generate a motion control instruction for each joint.

2. The method of claim 1, wherein the step of obtaining the state detecting result by detecting in the acceleration phase whether the height of the centroid of the robot reaches the start-hopping height, detecting in the flight phase whether the end force of the foot of one of the legs of the robot is greater than the threshold to suddenly change, and detecting in the deceleration phase whether the velocity of the centroid of the robot is decreased to close to zero comprises:
calculating a vertical velocity of the centroid of the robot, obtaining a corresponding velocity direction and velocity changing direction of the velocity, and determining whether the vertical velocity of the centroid is greater than a preset velocity threshold close to zero;
determining the robot as being in the during stage of the acceleration phase, in response to the vertical velocity of the centroid being greater than the preset velocity threshold and the corresponding velocity direction and velocity changing direction of the velocity being upward;
obtaining a planned transiting time of the robot to transit from the acceleration phase to the flight phase according to a centroid acceleration planning trajectory, determining whether the planned transiting time is up, and determining the robot as having entered the exit and state transiting stage of the acceleration phase in response to the planned transiting time being up and going to enter the desired entry stage of the flight phase in a next control cycle of the robot;
calculating a vertical force between a sole of the foot of the robot and a ground, obtaining a corresponding changing direction of the vertical force, and determining whether the vertical force is smaller than or equal to a first preset action force threshold to suddenly change;
determining the robot as having entered the actual entry stage of the flight phase, and going to be in the during stage in the flight phase in the next control cycle, in response to the changing direction of the vertical force being gradually decreasing and the vertical force being smaller than or equal to the first preset action force threshold;
determining the robot as being in the during stage of the flight phase, in response to the vertical force being smaller than or equal to the first preset action force threshold and retained unchanged;
determining the robot as having entered the exit and state transiting stage of the flight phase and going to enter the desired entry stage and the actual entry stage of the deceleration phase in the next control cycle, in response to the changing direction of the vertical force being gradually increasing and the vertical force being greater than or equal to a second preset action force threshold;
determining the robot as being in the during stage of the deceleration phase, in response to the corresponding velocity direction being downward, the corresponding velocity changing direction being upward, and the velocity in the vertical direction of the centroid being greater than the preset velocity threshold; and
determining the robot as having entered the exit and state transiting stage of the deceleration phase and going to enter the desired entry stage and the actual entry stage of the acceleration phase in the next control cycle, in response to the velocity direction being downward until the velocity in the vertical direction of the centroid being smaller than or equal to the preset velocity threshold.

3. The method of claim 2, wherein the sole of the robot is provided with at least a pressure sensor, and the step of calculating the vertical force between the sole of the robot and the ground comprises:
calculating the vertical force between the sole of the robot and the ground using the formula of:
\vec{F}=R_{foot}·\vec{F}ₛₑₙₛₒᵣ;
where, R_{foot} is a posture matrix of the sole of the robot, \vec{F}ₛₑₙₛₒᵣ is a measured sensor value of the pressure sensor, and \vec{F} is the vertical force.

4. The method of claim 3, wherein an end of each joint of the robot is provided with at least a torque sensor, and the step of calculating the vertical force between the sole of the robot and the ground comprises:
calculating the vertical force between the sole of the robot and the ground using the formula of:
\vec{F}=(J^{T})⁻¹·\vec{τ};
where, J^{T} is a transposed matrix of a Jacobian matrix of the centroid of the robot with respect to each joint, \vec{τ} is a column vector composed of the torque of each joint of the robot obtained using the torque sensor, and \vec{F} is the vertical force.

5. The method of claim 2, wherein the step of calculating the vertical velocity of the centroid of the robot comprises:
calculating the vertical velocity of the centroid of the robot using the formula of:
\vec{V}_{com}=J·\dot{Θ̅};
where, \dot{Θ̅} is an angular velocity corresponding to each joint of the robot, J is a Jacobian matrix of the centroid of the robot with respect to each joint, and \vec{V}ₒₘ i the velocity of the centroid of the robot, wherein the vertical velocity of the centroid is a vertical component of \vec{V}_{com}.

6. The method of claim 2, wherein the state information comprises a state name, a desired entry flag, an actual entry flag, a during flag, and an exit and state transiting flag, and step of updating the state information of the robot based on the state detecting result comprises:
setting the during flag corresponding to the acceleration phase as valid, in response to the state detecting result indicating the robot being in the during stage of the acceleration phase;
setting the exit and state transiting flag corresponding to the acceleration phase as valid in response to the state detecting result indicating the robot having entered the exit and state transiting stage of the acceleration phase, and setting the exit and state transiting flag corresponding to the flight phase as invalid and setting the desired entry flag corresponding to the flight phase as valid in response to the robot entering the desired entry stage of the flight phase in the next control cycle;
setting the desired entry flag corresponding to the flight phase as invalid and setting the actual entry flag corresponding to the flight phase as valid in response to the state detecting result indicating the robot having entered the actual entry stage of the flight phase, and setting the actual entry flag corresponding to the flight phase as invalid in response to the robot being in the during stage of the flight phase in the next control cycle;
setting the exit and state transiting flag corresponding to the flight phase as valid in response to the state detecting result indicating the robot having entered the exit and state transiting stage of the flight phase, setting the exit and state transiting flag corresponding to the flight phase as invalid and setting the desired entry flag and the actual entry flag corresponding to the deceleration phase as valid in response to the robot entering the desired entry stage and the actual entry stage of the deceleration phase in the next control cycle, and setting the desired entry flag and the actual entry flag corresponding to the deceleration phase as invalid and setting the during flag corresponding to the deceleration phase as valid in response to the robot being in the during stage of the deceleration phase; and
setting the exit and state transiting flag corresponding to deceleration phase as valid in response to the state detecting result indicating the robot having entered the exit and state transiting of the deceleration phase, and setting the exit and state transiting flag corresponding to deceleration phase as invalid and setting the desired entry flag and the actual entry flag corresponding to the acceleration phase as valid in response to the robot entering the desired entry stage and the actual entry stage of the acceleration phase in the next control cycle.

7. The method of claim 6, wherein the step of controlling the robot to transit between the stages of the acceleration phase, the flight phase, and the deceleration phase based on the updated state information comprises:
controlling the robot to enter the desired entry stage using the updated state name, resetting a timer, and generating an initial centroid planning trajectory, in response to the updated desired entry flag being valid;
controlling the robot to enter the actual entry stage using the updated state name and calculating and recording motion parameter information of the robot, in response to the updated actual entry flag being valid;
controlling the robot to enter the during stage using the updated state name and performing a centroid trajectory planning and a centroid velocity control based on the initial centroid planning trajectory and the motion parameter information, in response to the updated during flag being valid; and
controlling the robot to enter the terminating and transiting stage using the updated state name, in response to the updated exit and state transiting flag being valid.

8. A legged robot, comprising:
one or more legs each having at least a joint;
a memory;
a processor; and
one or more computer programs stored in the memory and executable on the processor;
flight
wherein the one or more computer programs comprise:
instructions for implementing a finite state machine comprising states, wherein the states comprises an acceleration phase, a flight phase, and a deceleration phase;
instructions for dividing each of the phases into a desired entry stage, an actual entry stage, a during stage, and an exit and state transiting stage, wherein the desired entry stage of the acceleration phase coincides with the actual entry stage of the acceleration phase, and the desired entry stage of the deceleration phase coincides with the actual entry stage of the deceleration phase;
instructions for obtaining a state detecting result by detecting in the acceleration phase whether a height of a centroid of the robot reaches a start-hopping height, detecting in the flight phase whether an end force of a foot of one of the legs of the robot is greater than a threshold to suddenly change, and detecting in the deceleration phase whether a velocity of the centroid of the robot is decreased to close to zero;
instructions for updating state information of the robot based on the state detecting result; and
instructions for controlling the robot to continuously hop by transiting between the stages of the acceleration phase, the flight phase, and the deceleration phase according to the updated state information.

9. The robot of claim 8, wherein the instructions for obtaining the state detecting result by detecting in the acceleration phase whether the height of the centroid of the robot reaches the start-hopping height, detecting in the flight phase whether the end force of the foot of one of the legs of the robot is greater than the threshold to suddenly change, and detecting in the deceleration phase whether the velocity of the centroid of the robot is decreased to close to zero comprise:
instructions for calculating a vertical velocity of the centroid of the robot, obtaining a corresponding velocity direction and velocity changing direction of the velocity, and determining whether the vertical velocity of the centroid is greater than a preset velocity threshold close to zero;
instructions for determining the robot as being in the during stage of the acceleration phase, in response to the vertical velocity of the centroid being greater than the preset velocity threshold and the corresponding velocity direction and velocity changing direction of the velocity being upward;
instructions for obtaining a planned transiting time of the robot to transit from the acceleration phase to the flight phase according to a centroid acceleration planning trajectory, determining whether the planned transiting time is up, and determining the robot as having entered the exit and state transiting stage of the acceleration phase in response to the planned transiting time being up and going to enter the desired entry stage of the flight phase in a next control cycle of the robot;
instructions for calculating a vertical force between a sole of the foot of the robot and a ground, obtaining a corresponding changing direction of the vertical force, and determining whether the vertical force is smaller than or equal to a first preset action force threshold to suddenly change;
instructions for determining the robot as having entered the actual entry stage of the flight phase, and going to be in the during stage in the flight phase in the next control cycle, in response to the changing direction of the vertical force being gradually decreasing and the vertical force being smaller than or equal to the first preset action force threshold;
instructions for determining the robot as being in the during stage of the flight phase, in response to the vertical force being smaller than or equal to the first preset action force threshold and retained unchanged;
instructions for determining the robot as having entered the exit and state transiting stage of the flight phase and going to enter the desired entry stage and the actual entry stage of the deceleration phase in the next control cycle, in response to the changing direction of the vertical force being gradually increasing and the vertical force being greater than or equal to a second preset action force threshold;
instructions for determining the robot as being in the during stage of the deceleration phase, in response to the corresponding velocity direction being downward, the corresponding velocity changing direction being upward, and the velocity in the vertical direction of the centroid being greater than the preset velocity threshold; and
instructions for determining the robot as having entered the exit and state transiting stage of the deceleration phase and going to enter the desired entry stage and the actual entry stage of the acceleration phase in the next control cycle, in response to the velocity direction being downward until the velocity in the vertical direction of the centroid being smaller than or equal to the preset velocity threshold.

10. The robot of claim 9, wherein the sole of the robot is provided with at least a pressure sensor, and the instructions for of calculating the vertical force between the sole of the robot and the ground comprise:
instructions for calculating the vertical force between the sole of the robot and the ground using the formula of:
\vec{F}=R_{foot}·\vec{F}ₛₑₙₛₒᵣ;
where, R_{foot} is a posture matrix of the sole of the robot, \vec{F}ₛₑₙₛₒᵣ is a measured value of the pressure sensor, and F is the vertical force.

11. The robot of claim 10, wherein an end of each joint of the robot is provided with at least a torque sensor, and the instructions for calculating the vertical force between the sole of the robot and the ground comprise:
instructions for calculating the vertical force between the sole of the robot and the ground using the formula of:
\vec{F}=(J^{T})⁻¹·\vec{τ};
where, J^{T} is a transposed matrix of a Jacobian matrix of the centroid of the robot with respect to each joint, i is a column vector composed of the torque of each joint of the robot obtained using the torque sensor, and \vec{F} is the vertical force.

12. The robot of claim 9, wherein the instructions for calculating the vertical velocity of the centroid of the robot comprise:
instructions for calculating the vertical velocity of the centroid of the robot using the formula of:
\vec{V}_{com}=J·\dot{Θ̅};
where, \dot{Θ̅} is an angular velocity corresponding to each joint of the robot, J is a Jacobian matrix of the centroid of the robot with respect to each joint, and \vec{V}_{com} i the velocity of the centroid of the robot, wherein the vertical velocity of the centroid is a vertical component of \vec{V}_{com}.

13. The robot of claim 9, wherein the state information comprises a state name, a desired entry flag, an actual entry flag, a during flag, and an exit and state transiting flag, and instructions for updating the state information of the robot based on the state detecting result comprise:
instructions for setting the during flag corresponding to the acceleration phase as valid, in response to the state detecting result indicating the robot being in the during stage of the acceleration phase;
instructions for setting the exit and state transiting flag corresponding to the acceleration phase as valid in response to the state detecting result indicating the robot having entered the exit and state transiting stage of the acceleration phase, and setting the exit and state transiting flag corresponding to the flight phase as invalid and setting the desired entry flag corresponding to the flight phase as valid in response to the robot entering the desired entry stage of the flight phase in the next control cycle;
instructions for setting the desired entry flag corresponding to the flight phase as invalid and setting the actual entry flag corresponding to the flight phase as valid in response to the state detecting result indicating the robot having entered the actual entry stage of the flight phase, and setting the actual entry flag corresponding to the flight phase as invalid in response to the robot being in the during stage of the flight phase in the next control cycle;
instructions for setting the exit and state transiting flag corresponding to the flight phase as valid in response to the state detecting result indicating the robot having entered the exit and state transiting stage of the flight phase, setting the exit and state transiting flag corresponding to the flight phase as invalid and setting the desired entry flag and the actual entry flag corresponding to the deceleration phase as valid in response to the robot entering the desired entry stage and the actual entry stage of the deceleration phase in the next control cycle, and setting the desired entry flag and the actual entry flag corresponding to the deceleration phase as invalid and setting the during flag corresponding to the deceleration phase as valid in response to the robot being in the during stage of the deceleration phase; and
instructions for setting the exit and state transiting flag corresponding to deceleration phase as valid in response to the state detecting result indicating the robot having entered the exit and state transiting of the deceleration phase, and setting the exit and state transiting flag corresponding to deceleration phase as invalid and setting the desired entry flag and the actual entry flag corresponding to the acceleration phase as valid in response to the robot entering the desired entry stage and the actual entry stage of the acceleration phase in the next control cycle.

14. The robot of claim 13, wherein the instructions for controlling the robot to transit between the stages of the acceleration phase, the flight phase, and the deceleration phase based on the updated state information comprises:
instructions for controlling the robot to enter the desired entry stage using the updated state name, resetting a timer, and generating an initial centroid planning trajectory, in response to the updated desired entry flag being valid;
instructions for controlling the robot to enter the actual entry stage using the updated state name and calculating and recording motion parameter information of the robot, in response to the updated actual entry flag being valid;
instructions for controlling the robot to enter the during stage using the updated state name and performing a centroid trajectory planning and a centroid velocity control based on the initial centroid planning trajectory and the motion parameter information, in response to the updated during flag being valid; and
instructions for controlling the robot to enter the terminating and transiting stage using the updated state name, in response to the updated exit and state transiting flag being valid.

15. A non-transitory computer readable storage medium storing instructions executable on a process to control a legged robot to continuously hop, wherein the robot has one or more legs each having at least a joint, wherein the robot has a plurality of states corresponding to a finite state machine for a continuous hopping model of the robot, and the states comprise an acceleration phase, a flight phase, and a deceleration phase;
wherein the instructions comprise:
instructions for implementing a finite state machine comprising states, wherein the states comprises an acceleration phase, a flight phase, and a deceleration phase;
instructions for dividing each of the phases into a desired entry stage, an actual entry stage, a during stage, and an exit and state transiting stage, wherein the desired entry stage of the acceleration phase coincides with the actual entry stage of the acceleration phase, and the desired entry stage of the deceleration phase coincides with the actual entry stage of the deceleration phase;
instructions for obtaining a state detecting result by detecting in the acceleration phase whether a height of a centroid of the robot reaches a start-hopping height, detecting in the flight phase whether an end force of a foot of one of the legs of the robot is greater than a threshold to suddenly change, and detecting in the deceleration phase whether a velocity of the centroid of the robot is decreased to close to zero;
instructions for updating state information of the robot based on the state detecting result; and
instructions for controlling the robot to continuously hop by transiting between the stages of the acceleration phase, the flight phase, and the deceleration phase according to the updated state information.

16. The storage medium of claim 15, wherein the instructions for obtaining the state detecting result by detecting in the acceleration phase whether the height of the centroid of the robot reaches the start-hopping height, detecting in the flight phase whether the end force of the foot of one of the legs of the robot is greater than the threshold to suddenly change, and detecting in the deceleration phase whether the velocity of the centroid of the robot is decreased to close to zero comprise:
instructions for calculating a vertical velocity of the centroid of the robot, obtaining a corresponding velocity direction and velocity changing direction of the velocity, and determining whether the vertical velocity of the centroid is greater than a preset velocity threshold close to zero;
instructions for determining the robot as being in the during stage of the acceleration phase, in response to the vertical velocity of the centroid being greater than the preset velocity threshold and the corresponding velocity direction and velocity changing direction of the velocity being upward;
instructions for obtaining a planned transiting time of the robot to transit from the acceleration phase to the flight phase according to a centroid acceleration planning trajectory, determining whether the planned transiting time is up, and determining the robot as having entered the exit and state transiting stage of the acceleration phase in response to the planned transiting time being up and going to enter the desired entry stage of the flight phase in a next control cycle of the robot;
instructions for calculating a vertical force between a sole of the foot of the robot and a ground, obtaining a corresponding changing direction of the vertical force, and determining whether the vertical force is smaller than or equal to a first preset action force threshold to suddenly change;
instructions for determining the robot as having entered the actual entry stage of the flight phase, and going to be in the during stage in the flight phase in the next control cycle, in response to the changing direction of the vertical force being gradually decreasing and the vertical force being smaller than or equal to the first preset action force threshold;
instructions for determining the robot as being in the during stage of the flight phase, in response to the vertical force being smaller than or equal to the first preset action force threshold and retained unchanged;
instructions for determining the robot as having entered the exit and state transiting stage of the flight phase and going to enter the desired entry stage and the actual entry stage of the deceleration phase in the next control cycle, in response to the changing direction of the vertical force being gradually increasing and the vertical force being greater than or equal to a second preset action force threshold;
instructions for determining the robot as being in the during stage of the deceleration phase, in response to the corresponding velocity direction being downward, the corresponding velocity changing direction being upward, and the velocity in the vertical direction of the centroid being greater than the preset velocity threshold; and
instructions for determining the robot as having entered the exit and state transiting stage of the deceleration phase and going to enter the desired entry stage and the actual entry stage of the acceleration phase in the next control cycle, in response to the velocity direction being downward until the velocity in the vertical direction of the centroid being smaller than or equal to the preset velocity threshold.

17. The storage medium of claim 16, wherein the sole of the robot is provided with at least a pressure sensor, and the instructions for of calculating the vertical force between the sole of the robot and the ground comprise:
instructions for calculating the vertical force between the sole of the robot and the ground using the formula of:
\vec{F}=R_{foot}·\vec{F}ₛₑₙₛₒᵣ;
where, R_{foot} is a posture matrix of the sole of the robot, \vec{F}ₛₑₙₛₒᵣ is a measured value of the pressure sensor, and F is the vertical force.

18. The storage medium of claim 17, wherein an end of each joint of the robot is provided with at least a torque sensor, and the instructions for calculating the vertical force between the sole of the robot and the ground comprise:
instructions for calculating the vertical force between the sole of the robot and the ground using the formula of:
\vec{F}=(J^{T})⁻¹·\vec{τ};
where, J^{T} is a transposed matrix of a Jacobian matrix of the centroid of the robot with respect to each joint, \vec{τ} is a column vector composed of the torque of each joint of the robot obtained using the torque sensor, and F is the vertical force.

19. The storage medium of claim 16, wherein the instructions for calculating the vertical velocity of the centroid of the robot comprise:
instructions for calculating the vertical velocity of the centroid of the robot using the formula of:
\vec{V}_{com}=J·\dot{Θ̅};
where, \dot{Θ̅} is an angular velocity corresponding to each joint of the robot, J is a Jacobian matrix of the centroid of the robot with respect to each joint, and \vec{V}_{com} i the velocity of the centroid of the robot, wherein the vertical velocity of the centroid is a vertical component of \vec{V}_{com}.

20. The storage medium of claim 16, wherein the state information comprises a state name, a desired entry flag, an actual entry flag, a during flag, and an exit and state transiting flag, and instructions for updating the state information of the robot based on the state detecting result comprise:
instructions for setting the during flag corresponding to the acceleration phase as valid, in response to the state detecting result indicating the robot being in the during stage of the acceleration phase;
instructions for setting the exit and state transiting flag corresponding to the acceleration phase as valid in response to the state detecting result indicating the robot having entered the exit and state transiting stage of the acceleration phase, and setting the exit and state transiting flag corresponding to the flight phase as invalid and setting the desired entry flag corresponding to the flight phase as valid in response to the robot entering the desired entry stage of the flight phase in the next control cycle;
instructions for setting the desired entry flag corresponding to the flight phase as invalid and setting the actual entry flag corresponding to the flight phase as valid in response to the state detecting result indicating the robot having entered the actual entry stage of the flight phase, and setting the actual entry flag corresponding to the flight phase as invalid in response to the robot being in the during stage of the flight phase in the next control cycle;
instructions for setting the exit and state transiting flag corresponding to the flight phase as valid in response to the state detecting result indicating the robot having entered the exit and state transiting stage of the flight phase, setting the exit and state transiting flag corresponding to the flight phase as invalid and setting the desired entry flag and the actual entry flag corresponding to the deceleration phase as valid in response to the robot entering the desired entry stage and the actual entry stage of the deceleration phase in the next control cycle, and setting the desired entry flag and the actual entry flag corresponding to the deceleration phase as invalid and setting the during flag corresponding to the deceleration phase as valid in response to the robot being in the during stage of the deceleration phase; and
instructions for setting the exit and state transiting flag corresponding to deceleration phase as valid in response to the state detecting result indicating the robot having entered the exit and state transiting of the deceleration phase, and setting the exit and state transiting flag corresponding to deceleration phase as invalid and setting the desired entry flag and the actual entry flag corresponding to the acceleration phase as valid in response to the robot entering the desired entry stage and the actual entry stage of the acceleration phase in the next control cycle.
